(19) United States
(12) Patent Application Publication
(10) Pub. No.: US 2020/0117362 A1
(43) Pub. Date: Apr. 16, 2020

(54) ERASURE CODING CONTENT DRIVEN DISTRIBUTION OF DATA BLOCKS

(71) Applicant: NetApp, Inc., Sunnyvale, CA (US)

(72) Inventors: Daniel David McCarthy, Erie, CO (US); Christopher Cason, Boulder, CO (US)

(21) Appl. No.: 16/545,992

(22) Filed: Aug. 20, 2019

Related U.S. Application Data
(60) Provisional application No. 62/745,538, filed on Oct. 15, 2018.

(51) Int. Cl. G06F 3/06; G06F 11/10

(52) U.S. Cl. CPC G06F 3/064; G06F 3/0652; G06F 3/0679; G06F 11/1076; G06F 3/0623

(57) ABSTRACT

A technique is configured to provide data protection, such as replication and erasure coding, of content driven distribution of data blocks served by storage nodes of a cluster. When providing data protection in the form of replication (redundancy), a slice service of the storage node generates one or more copies or replicas of a data block for storage on the cluster. Each replicated data block is illustratively organized within a bin that is maintained by block services of the nodes for storage on storage devices. When providing data protection in the form of erasure coding, the block services may select data blocks to be erasure coded. A set of data blocks for erasure coding may then be grouped together to form a write group. According to the technique, EC group membership is guided by varying bin groups so the data is resilient against failure. Slice services of the storage nodes assign data blocks of different bins and replicas to a write group.

### CROSS-REFERENCE TO RELATED APPLICATIONS

The present application claims the benefit of U.S. Provisional Patent Application Ser. No. 62/745,538, which was filed on Oct. 15, 2018, by Daniel David McCarthy and Christopher Lee Cason for Erasure Coding Unrelated Data Blocks, which is hereby incorporated by reference.

### BACKGROUND

### Technical Field

The present disclosure relates to protection of data served by storage nodes of a cluster and, more specifically, to erasure coding of content driven distributed data blocks served by the storage nodes of the cluster.

### Background Information

A plurality of storage nodes organized as a cluster may provide a distributed storage architecture configured to service storage requests issued by one or more clients of the cluster. The storage requests are directed to data stored on storage devices coupled to one or more of the storage nodes of the cluster. The data served by the storage nodes may be distributed across multiple storage units embodied as persistent storage devices, such as hard disk drives, solid state drives, flash memory systems, or other storage devices. The storage nodes may logically organize the data stored on the devices as volumes accessible as logical units (LUNs). Each volume may be implemented as a set of data structures, such as data blocks that store data for the volume and metadata blocks that describe the data of the volume. For example, the metadata may describe, e.g., identify, storage locations on the devices for the data. The data of each volume may be divided into data blocks. The data blocks may be distributed in a content driven manner throughout the nodes of the cluster so as to even out storage utilization and input/output (I/O) load across the cluster. To support increased durability of data, the data blocks may be replicated among the storage nodes.

To further improve storage capacity, a data redundancy method other than duplication, such as erasure coding, may be used. Unlike data duplication where no data is encoded and one or more copies of a data block are obtainable from non-failed nodes, some of the data is encoded with erasure coding and used for reconstruction in the event of node failure. However to support erasure coded methods of data redundancy within the cluster for data distributed in a content driven manner, specific techniques are needed for tracking encoded and unencoded data as well as providing for data recovery and for re-encoding data when data blocks change.

### BRIEF DESCRIPTION OF THE DRAWINGS

The above and further advantages of the embodiments herein may be better understood by referring to the following description in conjunction with the accompanying drawings in which like reference numerals indicate identically or functionally similar elements, of which:

FIG. 1 is a block diagram of a plurality of storage nodes interconnected as a storage cluster;

FIG. 2 is a block diagram of a storage node;

FIG. 3A is a block diagram of a storage service of the storage node;

FIG. 3B is a block diagram of an exemplary embodiment of the storage service;

FIG. 4 illustrates a write path of the storage node;

FIG. 5 is a block diagram illustrating details of a block identifier;

FIG. 6 illustrates an example workflow for a data protection scheme directed to erasure coding of data blocks;

FIG. 7 illustrates an example workflow for the erasure coding based data protection scheme directed to creation and storage of encoded blocks;

FIG. 8 is a flowchart illustrating operations of a method for storing and erasure coding data blocks; and

FIG. 9 is a flowchart illustrating operations of a method for reading a data block in an erasure coded system.

### OVERVIEW

The embodiments described herein are directed to a technique configured to provide data protection, such as replication and erasure coding, for content driven distribution of data blocks of logical volumes (“volumes”) served by storage nodes of a cluster. Illustratively, data blocks are distributed in the cluster using a cryptographic hash function of the data blocks associated with bins allotted (i.e., assigned) to storage services of the nodes. The cryptographic hash function illustratively provides a satisfactory random distribution of bits such that the data blocks may be distributed evenly within the nodes of the cluster. Each volume may be implemented as a set of data structures, such as data blocks that store data for the volume and metadata blocks that describe the data of the volume. The storage service implemented in each node includes a metadata layer having one or more metadata (slice) services configured to process and store the metadata, and a block server layer having one or more block services configured to process and store the data on storage devices of the node.

When providing data protection in the form of replication (redundancy), the slice service of the storage node generates one or more copies or replicas of a data block for storage on the cluster. For example, when providing triple replication protection of data, the slice service generates three replicas of the data block (i.e., an original replica 0, a “primary” replica 1 and a “secondary” replica 2) by synchronously replicating the data block to persistent storage of additional storage nodes in the cluster. Each replicated data block is illustratively organized within the allotted bin that is maintained by the block services of each of the nodes for storage on the storage devices. The slice service computes a corresponding bin number for the data block based on the cryptographic hash of the data block and consults a bin assignment table to identify the storage nodes to which the data block is written. In this manner, the bin assignment table tracks copies of the data block within the cluster. The slice services of the storage nodes then issue store requests to asynchronously flush copies of the data block to the block services associated with the identified storage devices. Notably, bins may be organized into a bin group based on an association, such as being on a same storage node or storage device.

When providing data protection in the form of erasure coding, the block services may select data blocks to be erasure coded. A set of data blocks may then be grouped together to form a write group for erasure coding. According to the technique, write group membership is guided by varying bin groups so that the data is resilient against failure, e.g., assignment based on varying a subset of bits in a bin identifier. The slice services route data blocks of different bins (e.g., having different bin groups) and replicas to their associated block services. The implementation varies with an EC scheme selected for deployment (e.g., 4 data blocks and 2 encoded blocks for correction, referred to as 4+2 EC). The block services assign the data blocks to bins according to the cryptographic hash and group a number of the different bins together based on the EC scheme deployed; for example, 4 bins may be grouped together in a 4+2 EC scheme (i.e., 4 unencoded data blocks+2 encoded blocks with correction information) and 8 bins may be grouped together in an 8+1 EC scheme. The write group of blocks from the different bins may be selected from data blocks temporarily spooled according to bin. That is, the data blocks of the different bins of the write group are selected (i.e., picked) according to bin from the pool of temporarily spooled blocks by bin so as to represent a wide selection of bins with differing failure domains resilient to data loss. Note that only the data blocks (i.e., unencoded blocks) need to be assigned to a bin, while the encoded blocks may be simply associated with the write group by reference to the data blocks of the write group.

Illustratively, the bins are assigned to the bin group in a manner that streamlines the erasure coding process. For example, in the case of the triple replication data protection scheme, wherein three replica versions (original replica 0, primary replica 1, and secondary replica 2) of each bin are generated, the bins in a bin group are assigned such that original replica 0 versions of the bins are assigned across multiple different block services, the primary replica 1 versions of the bins are assigned to a different block service, and the secondary replica 2 versions are assigned to yet another different block service. Data blocks may be stored in the bins in accordance with the replication-based data protection scheme until a sufficient number of blocks are available for the selected erasure coding deployment. One of the different block services functioning as a master replica (master replicate block service) coordinates the erasure coding process and selects a data block which is a candidate for erasure coding from each of the bins. The master replica block service forms a write group with the data blocks and generates one or more encoded correction (i.e., parity) blocks, e.g., primary and secondary parity blocks. The encoded parity blocks are stored with block identifiers for each of the data blocks used to generate the encoded blocks (i.e., each parity block includes a reference to the data blocks used to generate the respective parity block). Each replica block service updates its metadata mappings for the unencoded copies of the data blocks to point to (i.e., reference) the encoded data block (e.g., the primary and secondary parity blocks) locations on storage devices so that any read requests for the data blocks can return the encoded blocks. After storing and updating mappings for the encoded blocks, the master replica block service may free up the storage space occupied by the unencoded copies of the data blocks in the write group.

Further, if a data block is marked as inactive, e.g., deleted, another data block assigned to a same bin as the deleted data block may be allotted as a replacement, and the metadata mappings of each replica block service may be updated to reference the replaced block and the appropriate parity blocks may be recomputed. The replacement block may be selected from the pool of temporarily spooled blocks by bin.

### DESCRIPTION

Storage Cluster

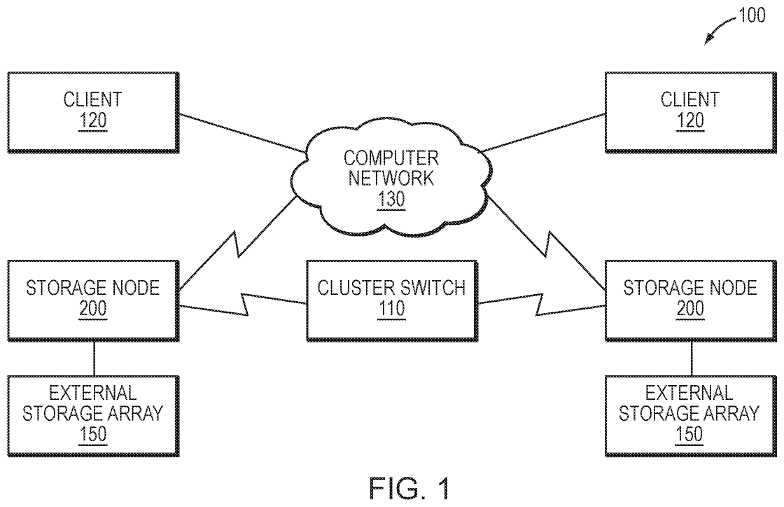

FIG. 1 is a block diagram of a plurality of storage nodes 200 interconnected as a storage cluster 100 and configured to provide storage service for information, i.e., data and metadata, organized and stored on storage devices of the cluster. The storage nodes 200 may be interconnected by a cluster switch 110 and include functional components that cooperate to provide a distributed, scale-out storage architecture of the cluster 100. The components of each storage node 200 include hardware and software functionality that enable the node to connect to and service one or more clients 120 over a computer network 130, as well as to a storage array 150 of storage devices, to thereby render the storage service in accordance with the distributed storage architecture.

Each client 120 may be embodied as a general-purpose computer configured to interact with the storage node 200 in accordance with a client/server model of information delivery. That is, the client 120 may request the services of the node 200, and the node may return the results of the services requested by the client, by exchanging packets over the network 130. The client may issue packets including file-based access protocols, such as the Network File System (NFS) and Common Internet File System (CIFS) protocols over the Transmission Control Protocol/Internet Protocol (TCP/IP), when accessing information on the storage node in the form of storage objects, such as files and directories. However, in an embodiment, the client 120 illustratively issues packets including block-based access protocols, such as the Small Computer Systems Interface (SCSI) protocol encapsulated over TCP (iSCSI) and SCSI encapsulated over FC (FCP), when accessing information in the form of storage objects such as logical units (LUNs).

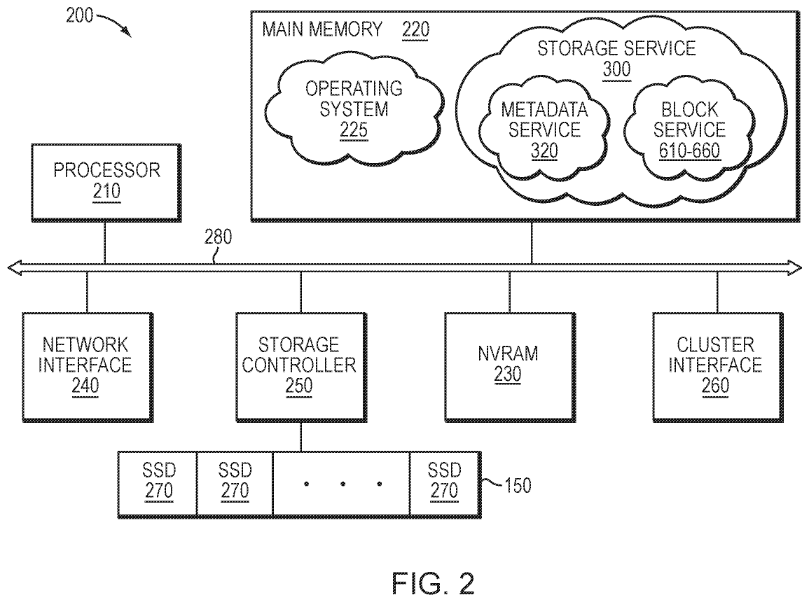

FIG. 2 is a block diagram of storage node 200 illustratively embodied as a computer system having one or more processing units (processors) 210, a main memory 220, a non-volatile random access memory (NVRAM) 230, a network interface 240, one or more storage controllers 250 and a cluster interface 260 interconnected by a system bus 280. The network interface 240 may include one or more ports adapted to couple the storage node 200 to the client(s) 120 over computer network 130, which may include point-to-point links, wide area networks, virtual private networks implemented over a public network (Internet) or a shared local area network. The network interface 240 thus includes the mechanical, electrical and signaling circuitry needed to connect the storage node to the network 130, which may embody an Ethernet or Fibre Channel (FC) network.

The main memory 220 may include memory locations that are addressable by the processor 210 for storing software programs and data structures associated with the embodiments described herein. The processor 210 may, in turn, include processing elements and/or logic circuitry configured to execute the software programs, such as one or more metadata services 320a-n and block services 610-660 of storage service 300, and manipulate the data structures. An operating system 225, portions of which are typically resident in memory 220 (in-core) and executed by the processing elements (e.g., processor 210), functionally organizes the storage node by, inter alia, invoking operations in support of the storage service 300 implemented by the node. A suitable operating system 225 may include a general-purpose operating system, such as the UNIX® series or Microsoft Windows® series of operating systems, or an operating system with configurable functionality such as microkernels and embedded kernels. However, in an embodiment described herein, the operating system is illustratively the Linux® operating system. It will be apparent to those skilled in the art that other processing and memory means, including various computer readable media, may be used to store and execute program instructions pertaining to the embodiments herein.

The storage controller 250 cooperates with the storage service 300 implemented on the storage node 200 to access information requested by the client 120. The information is preferably stored on storage devices such as internal solid state drives (SSDs) 270, illustratively embodied as flash storage devices, as well as SSDs of external storage array 150 (i.e., an additional storage array attached to the node). In an embodiment, the flash storage devices may be block-oriented devices (i.e., drives accessed as blocks) based on NAND flash components, e.g., single-layer-cell (SLC) flash, multi-layer-cell (MLC) flash or triple-layer-cell (TLC) flash, although it will be understood to those skilled in the art that other block-oriented, non-volatile, solid-state electronic devices (e.g., drives based on storage class memory components) may be advantageously used with the embodiments described herein. The storage controller 250 may include one or more ports having I/O interface circuitry that couples to the SSDs 270 over an I/O interconnect arrangement, such as a conventional serial attached SCSI (SAS) and serial ATA (SATA) topology.

The cluster interface 260 may include one or more ports adapted to couple the storage node 200 to the other node(s) of the cluster 100. In an embodiment, dual 10 Gbps Ethernet ports may be used for internode communication, although it will be apparent to those skilled in the art that other types of protocols and interconnects may be utilized within the embodiments described herein. The NVRAM 230 may include a back-up battery or other built-in last-state retention capability (e.g., non-volatile semiconductor memory such as storage class memory) that is capable of maintaining data in light of a failure to the storage node and cluster environment.

Storage Service

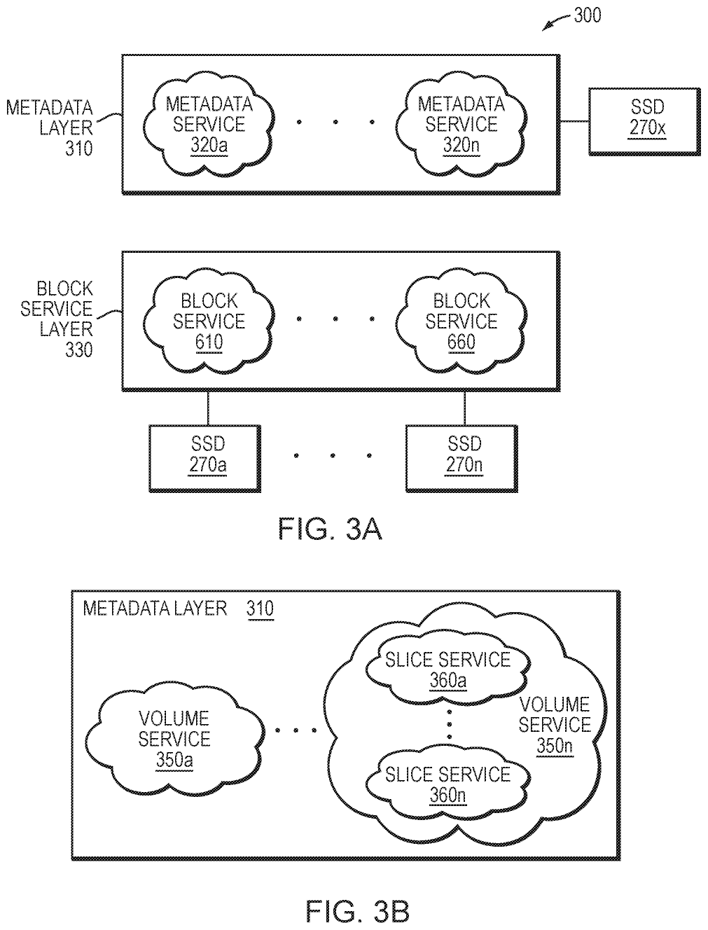

FIG. 3A is a block diagram of the storage service 300 implemented by each storage node 200 of the storage cluster 100. The storage service 300 is illustratively organized as one or more software modules or layers that cooperate with other functional components of the nodes 200 to provide the distributed storage architecture of the cluster 100. In an embodiment, the distributed storage architecture aggregates and virtualizes the components (e.g., network, memory, and compute resources) to present an abstraction of a single storage system having a large pool of storage, i.e., all storage, including internal SSDs 270 and external storage arrays 150 of the nodes 200 for the entire cluster 100. In other words, the architecture consolidates storage throughout the cluster to enable storage of the LUNs, each of which may be apportioned into one or more logical volumes (“volumes”) having a logical block size of either 4096 bytes (4 KB) or 512 bytes. Each volume may be further configured with properties such as size (storage capacity) and performance settings (quality of service), as well as access control, and may be thereafter accessible (i.e., exported) as a block storage pool to the clients, preferably via iSCSI and/or FCP. Both storage capacity and performance may then be subsequently “scaled out” by growing (adding) network, memory and compute resources of the nodes 200 to the cluster 100.

Each client 120 may issue packets as input/output (I/O) requests, i.e., storage requests, to access data of a volume served by a storage node 200, wherein a storage request may include data for storage on the volume (i.e., a write request) or data for retrieval from the volume (i.e., a read request), as well as client addressing in the form of a logical block address (LBA) or index into the volume based on the logical block size of the volume and a length. The client addressing may be embodied as metadata, which is separated from data within the distributed storage architecture, such that each node in the cluster may store the metadata and data on different storage devices (e.g., data on SSDs 270a-n and metadata on SSD 270x) of the storage coupled to the node. To that end, the storage service 300 implemented in each node 200 includes a metadata layer 310 having one or more metadata services 320a-n configured to process and store the metadata, e.g., on SSD 270x, and a block server layer 330 having one or more block services 610-660 configured to process and store the data, e.g., on the SSDs 270a-n. For example, the metadata services 320a-n map between client addressing (e.g., LBA indexes) used by the clients to access the data on a volume and block addressing (e.g., block identifiers) used by the block services 610-660 to store and/or retrieve the data on the volume, e.g., of the SSDs.

FIG. 3B is a block diagram of an alternative embodiment of the storage service 300. When issuing storage requests to the storage nodes, clients 120 typically connect to volumes (e.g., via indexes or LBAs) exported by the nodes. To provide an efficient implementation, the metadata layer 310 may be alternatively organized as one or more volume services 350a-n, wherein each volume service 350 may perform the functions of a metadata service 320 but at the granularity of a volume, i.e., process and store the metadata for the volume. However, the metadata for the volume may be too large for a single volume service 350 to process and store; accordingly, multiple slice services 360a-n may be associated with each volume service 350. The metadata for the volume may thus be divided into slices and a slice of metadata may be stored and processed on each slice service 360. In response to a storage request for a volume, a volume service 350 determines which slice service 360a-n contains the metadata for that volume and forwards the request the appropriate slice service 360.

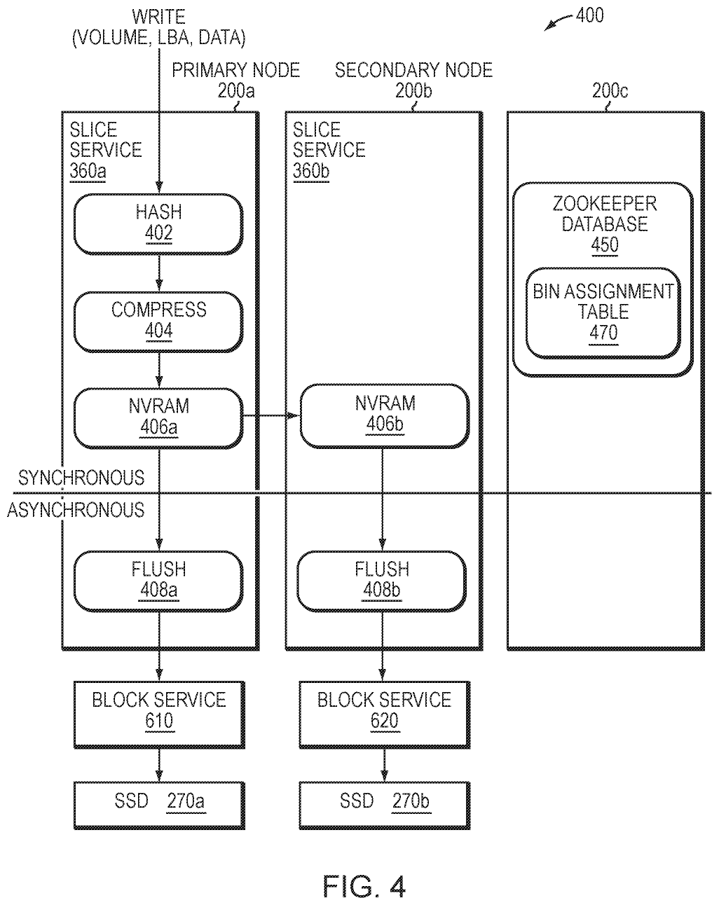

FIG. 4 illustrates a write path 400 of a storage node 200 for storing data on a volume of a storage array 150. In an embodiment, an exemplary write request issued by a client 120 and received at a storage node 200 (e.g., primary node 200a) of the cluster 100 may have the following form:
write (volume, LBA, data)

wherein the volume specifies the logical volume to be written, the LBA is the logical block address to be written, and the data is logical block size of the data to be written. Illustratively, the data received by a slice service 360a of the storage node 200a is divided into 4 KB block sizes. At box 402, each 4 KB data block is hashed using a conventional cryptographic hash function to generate a 128-bit (16B) hash value (recorded as a block identifier (ID) of the data block); illustratively, the block ID is used to address (locate) the data on the internal SSDs 270 as well as the external storage array 150. A block ID is thus an identifier of a data block that is generated based on the content of the data block. The conventional cryptographic hash function, e.g., Skein algorithm, provides a satisfactory random distribution of bits within the 16B hash value/block ID employed by the technique. At box 404, the data block is compressed using a conventional, e.g., LZW (Lempel-Zif-Welch), compression algorithm and, at box 406a, the compressed data block is stored in NVRAM 230. Note that, in an embodiment, the NVRAM 230 is embodied as a write cache. Each compressed data block is then synchronously replicated to the NVRAM 230 of one or more additional storage nodes (e.g., secondary storage node 200b) in the cluster 100 for data protection (box 406b). An acknowledgement is returned to the client when the data block has been safely and persistently stored in the NVRAM 230a,b of the multiple storage nodes 200a,b of the cluster 100.

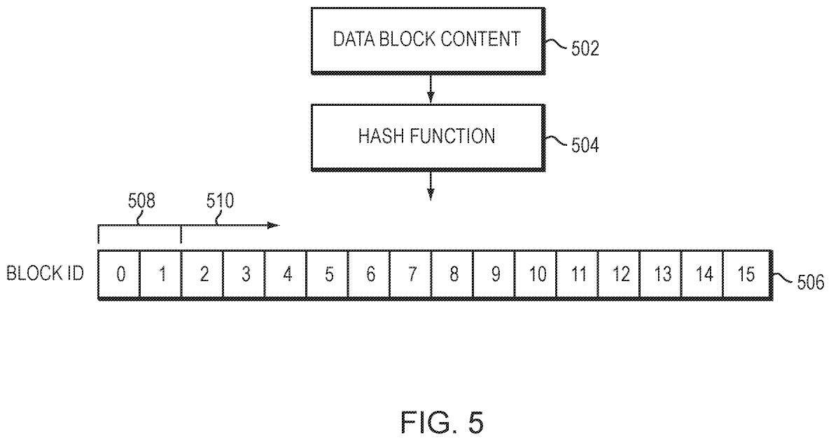

FIG. 5 is a block diagram illustrating details of a block identifier. In an embodiment, content 502 for a data block is received by storage service 300. As described above, the received data is divided into data blocks having content 502 that may be processed using hash function 504 to determine block identifiers (IDs) 506. That is, the data is divided into 4 KB data blocks, and each data block is hashed to generate a 16B hash value recorded as a block ID 506 of the data block; illustratively, the block ID 506 is used to locate the data on one or more storage devices 270 of the storage array 150. The data is illustratively organized within bins that are maintained by a block service 610-660 for storage on the storage devices. A bin may be derived from the block ID for storage of a corresponding data block by extracting a predefined number of bits from the block ID 506.

In an embodiment, the bin may be divided into buckets or “sublists” by extending the predefined number of bits extracted from the block ID. For example, a bin field 508 of the block ID may contain the first two (e.g., most significant) bytes (2B) of the block ID 506 used to generate a bin number (identifier) between 0 and 65,535 (depending on the number of 16 bits used) that identifies a bin. The bin identifier may also be used to identify a particular block service 610-660 and associated SSD 270. A sublist field 510 may then contain the next byte (1B) of the block ID used to generate a sublist identifier between 0 and 255 (depending on the number of 8 bits used) that identifies a sublist with the bin. Dividing the bin into sublists facilitates, inter alia, network transfer (or syncing) of data among block services in the event of a failure or crash of a storage node. The number of bits used for the sublist identifier may be set to an initial value, and then adjusted later as desired. Each block service 610-660 maintains a mapping between the block ID and a location of the data block on its associated storage device/SSD, i.e., block service drive (BSD).

Illustratively, the block ID (hash value) may be used to distribute the data blocks among bins in an evenly balanced (distributed) arrangement according to capacity of the SSDs, wherein the balanced arrangement is based on “coupling” between the SSDs, i.e., each node/SSD shares approximately the same number of bins with any other node/SSD that is not in a same failure domain, i.e., protection domain, of the cluster. As a result, the data blocks are distributed across the nodes of the cluster based on content (i.e., content driven distribution of data blocks). This is advantageous for rebuilding data in the event of a failure (i.e., rebuilds) so that all SSDs perform approximately the same amount of work (e.g., reading/writing data) to enable fast and efficient rebuild by distributing the work equally among all the SSDs of the storage nodes of the cluster. In an embodiment, each block service maintains a mapping of block ID to data block location on storage devices (e.g., internal SSDs 270 and external storage array 150) coupled to the node.

Illustratively, bin assignments may be stored in a distributed key-value store across the cluster. Referring again to FIG. 4, the distributed key-value storage may be embodied as, e.g., a “zookeeper” database 450 configured to provide a distributed, shared-nothing (i.e., no single point of contention and failure) database used to store bin assignments (e.g., a bin assignment table) and configuration information that is consistent across all nodes of the cluster. In an embodiment, one or more nodes 200c has a service/process associated with the zookeeper database 450 that is configured to maintain the bin assignments (i.e., mappings) in connection with a data structure, e.g., bin assignment table 470. Illustratively the distributed zookeeper is resident on up to, e.g., five (5) selected nodes in the cluster, wherein all other nodes connect to one of the selected nodes to obtain the bin assignment information. Thus, these selected “zookeeper” nodes have replicated zookeeper database images distributed among different failure domains of nodes in the cluster so that there is no single point of failure of the zookeeper database. In other words, other nodes issue zookeeper requests to their nearest zookeeper database image (zookeeper node) to obtain current bin assignments, which may then be cached at the nodes to improve access times.

For each data block received and stored in NVRAM 230a,b, the slice services 360a,b compute a corresponding bin number and consult the bin assignment table 470 to identify the SSDs 270a,b to which the data block is written. At boxes 408a,b, the slice services 360a,b of the storage nodes 200a,b then issue store requests to asynchronously flush copies of the compressed data block to the block services (illustratively labelled 610,620) associated with the identified SSDs. An exemplary store request issued by each slice service 360a,b and received at each block service 610,620 may have the following form:
store (block ID, compressed data)

The block service 610,620 for each SSD 270a,b (or storage devices of external storage array 150) determines if it has previously stored a copy of the data block. If not, the block service 610,620 stores the compressed data block associated with the block ID on the SSD 270a,b. Note that the block storage pool of aggregated SSDs is organized by content of the block ID (rather than when data was written or from where it originated) thereby providing a “content addressable” distributed storage architecture of the cluster. Such a content-addressable architecture facilitates deduplication of data “automatically” at the SSD level (i.e., for “free”), except for at least two copies of each data block stored on at least two SSDs of the cluster. In other words, the distributed storage architecture utilizes a single replication of data with inline deduplication of further copies of the data, i.e., there are at least two copies of data for redundancy purposes in the event of a hardware failure.

Erasure Coding of Content Driven Distribution of Data Blocks

The embodiments described herein are directed to a technique configured to provide data protection, such as replication and erasure coding, of content driven distribution of data blocks of volumes served by storage nodes of a cluster. As stated previously, data blocks may be distributed in the cluster using the cryptographic hash function of the data blocks associated with bins allotted (i.e., assigned) to storage services of the nodes. The cryptographic hash function provides a satisfactory random distribution of bits such that the data blocks may be distributed evenly within the nodes of the cluster. Each volume may be implemented as a set of data structures, such as data blocks that store data for the volume and metadata blocks that describe the data of the volume. The storage service implemented in each node includes a metadata layer having one or more metadata (slice) services configured to process and store the metadata, and a block server layer having one or more block services configured to process and store the data on storage devices of the node.

To increase durability of data, the storage node may implement data protection, such as replication, for the data blocks of the volume. When providing data protection in the form of replication (redundancy), the storage node duplicates blocks of the data and sends the duplicate data blocks to additional storage devices. The slice service of the storage node generates one or more copies or replicas of a data block for storage on the cluster, as described above. For example, when providing triple replication protection of data, the slice service generates three replicas of the data block (i.e., an original replica 0, a “primary” replica 1 and a “secondary” replica 2) by synchronously replicating the data block to persistent storage of additional storage nodes in the cluster. Each replicated data block is illustratively organized within the allotted bin that is maintained by the block services of each of the nodes for storage on the storage devices. The slice service computes a corresponding bin number for the data block based on the cryptographic hash of the data block and consults a bin assignment table to identify the storage devices of the storage nodes to which the data block is written. The slice services of the storage nodes then issue store requests to asynchronously flush a copy of the data block to the block services associated with the identified storage devices. Notably, bins may be organized into a bin group based on an association, such as being on a same storage node or storage device.

When providing data protection in the form of erasure coding, an erasure code is used to algorithmically generate encoded blocks in addition to the data blocks. In general, an erasure code algorithm, such as Reed Solomon, uses n blocks of data to create an additional k blocks (n+k), where k is a number of encoded blocks of redundancy or “parity” used for data protection. Erasure coded data allows missing blocks to be reconstructed from any n blocks of the n+k blocks. For example, an 8+3 erasure coding scheme, i.e. n=8 and k=3, transforms eight blocks of data into eleven blocks of data/parity. In response to a read request, the data may then be reconstructed from any eight of the eleven blocks.

In an embodiment, the block services may select data blocks to be erasure coded. A set of data blocks may then be grouped together to form an erasure coding (EC) group. According to the technique, write group membership is guided by varying bin groups, e.g., assignment based on varying a subset of bits in a bin identifier (e.g., upper 14 bits of a 16 bit identifier). The slice services route data blocks of different bins (e.g., having different bin groups) and replicas to their associated block services. The implementation varies with the EC scheme selected for deployment (e.g., 4 data blocks+2 encoded blocks for correction, referred to as 4+2 EC). The block services may organize the data blocks according to their assigned bins (i.e., based on the bin assignment table according to the cryptographic hash of each block) to group a number of the different bins together (thus forming a write group) based on the EC scheme deployed; for example, 4 bins may be grouped together in a 4+2 EC scheme (i.e., 4 unencoded data blocks+2 encoded blocks with correction information) and 8 bins may be grouped together in an 8+1 EC scheme. The write group of blocks from the different bins may be selected from data blocks temporarily spooled according to bin. That is, the data blocks of the different bins of the write group are selected (i.e., picked) according to bin from the pool of temporarily spooled blocks by bin so as to represent a wide selection of bins with differing failure domains resilient to data loss. Note that only the data blocks (i.e., unencoded blocks) need to be assigned to a bin, while the encoded blocks may simply be associated with the write group by reference to the data blocks of the write group. Notably, replication is performed essentially by the slice services routing data blocks and their replicas to the block services; whereas the block services may erasure code data blocks received from the slice services by organizing write groups having encoded (e.g., parity) blocks.

Illustratively, the bins are assigned to the bin group in a manner that streamlines the erasure coding process. As used herein, a bin group identifies bins from which data blocks are to be selected for data protection using erasure coding. For example, in the case of the triple replication data protection scheme, wherein three replica versions (original replica 0, primary replica 1, and secondary replica 2) of each bin are generated, the bins in a bin group are assigned such that the original replica 0 versions of the bins are assigned across multiple different block services, the primary replica 1 versions of the bins are assigned to a different block service, and the secondary replica 2 versions are assigned to yet another different block service. Data blocks may be stored in the bins in accordance with the replication-based data protection scheme until a sufficient number of blocks are available for the selected erasure coding deployment.

One of the different block services functioning as a master replica (master replicate block service) coordinates the erasure coding process and selects a data block which is a candidate for erasure coding from each of the bins (i.e., the write group). The master replica block service forms a write group with the data blocks and generates one or more encoded correction (i.e., parity) blocks, e.g., primary and secondary parity blocks. The encoded parity blocks are stored with block identifiers for each of the data blocks used to generate encoded blocks (i.e., each parity block includes a reference to the data blocks used to generate the respective parity block). The master replica block service updates its metadata mappings for the unencoded copies of the data blocks to point to (i.e., reference) the encoded data block locations (i.e., primary and secondary parity blocks) on storage devices so that any read requests for the data blocks can return the encoded blocks. After storing and updating mappings for the encoded blocks, the master replica block service may free up the space occupied by the unencoded copies of the data blocks in the write group.

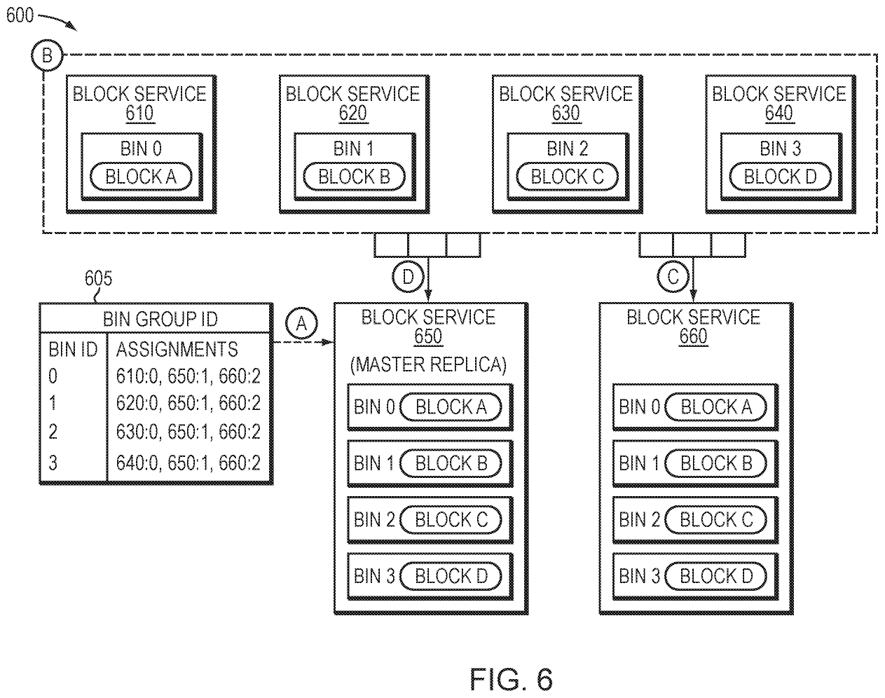

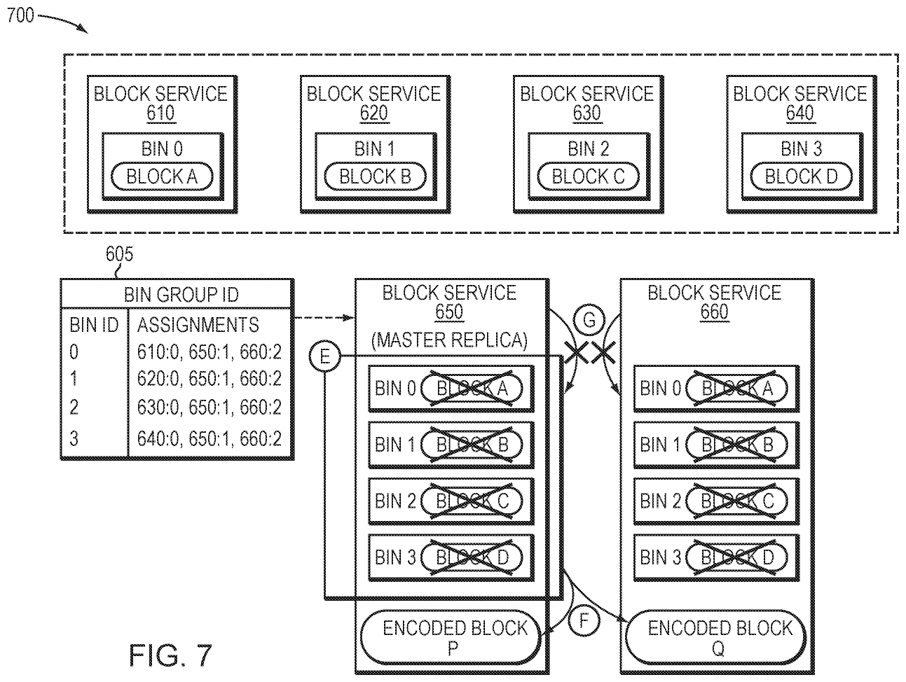

FIGS. 6 and 7 illustrate example workflows for a data protection scheme directed to erasure coding of data blocks. It should be noted that the workflows are annotated with a series of letters A-G that represent stages of operations. Although ordered for the workflow(s), the stages illustrate one example to aid in understanding the disclosure and should not be used to limit the claims. Subject matter falling within the scope of the claims can vary with respect to the order and some of the operations.

Referring to the workflow 600 of FIG. 6, block services 610-660 may each execute on their own storage node 200 of the cluster 100, may all execute on the same node, or any combination of the foregoing. The block service 610, the block service 620, the block service 630, and the block service 640 maintain (“host”) a bin 0, a bin 1, a bin 2, and a bin 3, respectively (collectively referred to as “the bins”), such that the bins are assigned to and managed by their corresponding block service. It should be noted that each block service may further be assigned and manage additional bins.

At stage A, the block service 650 receives a bin group assignment 605 specifying a bin group. Note that the bin group assignment may be based on a subset of bits of the block ID computed from the cryptographic hash used to distribute blocks within the cluster, e.g., lower bits n of the block ID may be used according to a number of 2ⁿ input data blocks employed in the EC scheme. That is, the number of bins in a bin group corresponds to a number of input data blocks for an erasure coding scheme; for example, a 4+2 EC scheme (as described in the workflow 600) uses four bins. Thus, the bin group assignment 605 specifies four bins: bin 0, bin 1, bin 2, and bin 3 (e.g., lower two bits of block ID, as 2²=4 data blocks). The bin group assignment 605 also specifies that the primary (master) replica block service 650 and the secondary replica block service 660 store replicas for each of the bins. As indicated by the assignments “650:1” and “660:2,” the block service hosting replica 1 is designated as the master block service 650 for each bin in the bin group, and the secondary replica block service 660 hosts replica 2 for each bin in the bin group. The bin group assignment 605 may have been generated by a master/manager of the cluster 100 (“cluster master/manager”) or other service which handles bin assignments (not depicted).

The cluster 100 may include a number of versions or copies of each bin depending on the data protection schemes supported by the cluster 100. For example, for triple replication and a 4+2 erasure coding scheme, the cluster 100 includes three versions of each bin, referred to as replica 0, replica 1, and replica 2, hosted by various block services. To support erasure coding based protection schemes, the bin assignment service ensures that (i) each original replica 0 version of bins selected for a bin group is assigned to a different block service (e.g., bins 0-3 are assigned across block services 610-640), (ii) the primary replica 1 versions of the bins are assigned to a same block service (e.g., all of the replica 1's are assigned to the master replica block service 650) and (iii) the secondary replica 2 versions of the bins are assigned to a same block service (e.g., all of the replica 2's are assigned to the secondary replica block service 660).

The bin assignment service may also assign the bins in such a manner so that the bins are located across different failure domains. For example, each bin may be assigned to or selected from a different solid state drive (SSD), a different storage node, and/or a different chassis. Moreover, the bin assignment service may ensure that no block service hosts replicas of a block for the same bin so as to ensure no storage device stores more than one block from the same bin group (i.e., write group). The bin assignment service makes the bin group assignment 605 available to all block services including the primary and secondary replica block services 650 and 660. As noted, the block service 650 hosts a primary encoded replica and, thus, functions as the master replica block service 650 that uses the bin group assignment 605 to coordinate the erasure coding process, whereas the block service 660 hosts a secondary encoded replica and functions as the secondary replica block service 660.

At stage B, data blocks A-D are flushed (“written”) to the block services that host bins for replica 0 copies of the data blocks, e.g., bin 0, bin 1, bin 2, and bin 3, respectively. For example, block A may be a portion of data from a first volume, block B may be data from a second volume, etc. Additionally, the data blocks may have been compressed or encrypted prior to storage. The data blocks are stored across the bins assigned to each of the block services. As noted above, the data block can be assigned to and stored in a bin (identified by a bin number) based on “leading” bits of the bin field 508 of the block ID 506. Block A, for example, may be assigned to the bin 0 based on a bin number having a leading bit of 0 in the bin field 508.

As a result of deduplication, a data block can include data which is used by multiple volumes having varying data protection schemes, such as replication and/or erasure coding schemes. According to the technique, each data block is protected at the highest-level protection scheme (i.e., the highest required failure tolerance) configured by any one of the volumes which uses the data block. In the workflow 600 of FIG. 6, each data block belongs to at least one volume that has been configured with a 4+2 erasure coding scheme.

At stages C and D, the data blocks are written to the replicas of the bins hosted by replica block services 650 and 660. Although the stages of the workflow 600 generally indicate the order with which each block is written or flushed to the block services, stages B and C can occur in parallel. However, stage D occurs after stages B and C so that the master replica block service 650 can be assured that data blocks have been successfully stored by other block services once the data blocks are received at the block service 650. For example, Block A is first flushed to block service 610 and written to bin 0 at stage B, and at stage C, the block A is written to the secondary replica of the bin 0 by the secondary replica block service 660. Finally, at stage D, the block A is written to the master replica of the bin 0 by the master replica block service 650. Each of the data blocks is preferably written in this order. Since the block service 650 is the master replica block service configured to coordinate the erasure coding process, the data blocks are written to master replica block service 650 last to ensure that the data blocks are fully replicated across all block services prior to the block service 650 initiating the erasure coding process. Once a data block is received and available from each bin of the bin group, the master replica block service 650 can begin the erasure coding process, as described in FIG. 7.

In some implementations, however, the writing of the data blocks to the replica block services 650 and 660 at stages C and D prior to erasure coding is not necessary. For example, the master replica block service 650 could read the data blocks from the block services 610-640 and generate encoded blocks as shown in FIG. 6 without the data blocks first being replicated. However, writing the data blocks prior to erasure coding ensures that configured volume (data) protection schemes or service level agreements (SLAs) related to data protection are satisfied while the erasure coding process is pending. As noted above, the data blocks may be written at different times. Significant time may pass, for example, between the time when block A is written and block D is written. Therefore, to ensure that block A and the other data blocks can tolerate two failures, as may be required by a volume's data protection scheme or SLA, the data blocks are triple replicated and remain triple replicated until the erasure coding process is complete.

The workflow 700 of FIG. 7 is a continuation of workflow 600 (FIG. 6) and illustrates the creation and storage of encoded blocks. At stage E, the master replica block service 650 identifies and forms a write group having the data blocks A, B, C, and D. When forming the write group, the master replica block service 650 selects one block from each bin identified in the bin group assignment 605. The blocks may be selected according to various heuristics, such as selecting blocks which are of a similar size.

At stage F, the master replica block service 650 generates and stores an encoded parity block P within its own storage, e.g., BSD, and generates an encoded parity block Q and sends a write command with the encoded block Q to the secondary replica block service 660 for storage with its own BSD. The master replica block service 650 reads its replicas of the data blocks A, B, C, and D and processes them using an erasure coding algorithm to generate the encoded parity block P and encoded parity block Q. In some instances, if there are not enough blocks for an erasure coding scheme, e.g. only three blocks are available, the master replica block service 650 can be configured to use a block of 0s or 1s as a substitute for an actual data block. The master replica block service 650 may be configured as such in instances where data blocks have been unencoded for a threshold amount of time or to substitute for a previously encoded block which has been deleted.

In some implementations, rather than generating the encoded parity block Q, the master replica block service 650 may send block identifiers (block IDs) for the data blocks in the write group to the secondary replica block service 660, and the secondary replica block service 660 generates the encoded parity block Q. Illustratively, the encoded parity blocks are stored with the block IDs for each of the data blocks A, B, C, and D. For example, the block IDs may be prepended or appended to the encoded parity blocks. The master replica block service 650 updates the metadata entries, e.g., of respective map fragments, for the data blocks A, B, C, and D with a mapping that points to the encoded parity block P on the BSD of the block service 650 in addition to the existing location mappings for the data blocks. The secondary replica block service 660 similarly updates its mappings for the data blocks to include the location of the encoded parity block Q on the BSD of block service 660.

In an embodiment, some erasure coding algorithms require blocks to be the same size. If any of the data blocks have a different size, the data blocks can be padded or filled with bits (0s or 1s) up to the size of the largest data block. The original length of each data block is stored along with the encoded parity block P and the encoded parity block Q so that any padding added to a data block can be removed after decoding. Additionally, the data blocks may have been compressed using different compression algorithms. The compression algorithm used on data blocks may change as storage optimizations, such as background recompression, are performed. The compression algorithm applied to a data block at the time the encoded parity blocks are created is also stored along with the encoded blocks. During a decoding process, the original compression algorithm (i.e., the algorithm applied at the time of encoding) is compared with the current compression algorithm of an unencoded data block being used in the decoding process. If the compression algorithms do not match, the data block is decompressed and then recompressed using the original compression algorithm prior to decoding.

Since the encoded parity blocks P and Q have been created, the data blocks A, B, C, and D are now protected by the 4+2 erasure coding scheme and can still be read even after two failures. As a result, the unencoded copies of the data blocks may be deleted to free up storage space. Accordingly, at stage G, the master replica block service 650 marks the unencoded copies of the data blocks A, B, C, and D as inactive and then deletes those marked copies of the data blocks from its storage (BSD). Similarly, the secondary replica block service 660 marks (as inactive) the data blocks A, B, C, and D, and thereafter deletes those marked unencoded copies of the data blocks from its storage (BSD). Deletion of the data blocks may involve removing block identifiers for the blocks from metadata or otherwise indicating the storage space consumed by the data blocks as free.

In some implementations, the replica block services 650 and 660 may leave the unencoded copies of the data blocks A, B, C, and D, and update the metadata to include two (or three) mappings for each of the data blocks A, B, C, and D: one to the unencoded blocks and one (or two) to the encoded parity block(s). In general, the metadata may have multiple entries for a given block identifier, which entries are illustratively maintained in the same area of the metadata (e.g., map fragment) so that optimal results can be returned for a given request. In some cases, a request may be better served with an unencoded copy of the data block, whereas another request may need the encoded parity copy of the block. In such an implementation, the unencoded data blocks remain available for retrieval (via read operations) until garbage collection and/or recycling processes are performed, which may delete the data blocks if storage space is needed. In some instances, the garbage collection and/or recycling processes could determine that storage space does not need to be reclaimed and leave the data blocks as stored.

Operations similar to those described above can be utilized for different erasure coding schemes. Because a 4+2 erasure coding scheme is utilized in the workflows 600 and 700 described herein, bin groups including 4 bins and 2 replicas (i.e., three total copies of a data block) of each bin are generated. That is, to maintain a consistent level of redundancy between EC and replication coding data redundancy schemes, a number of replicas equal to a number of encoded (i.e., correction) blocks of the EC scheme is used.

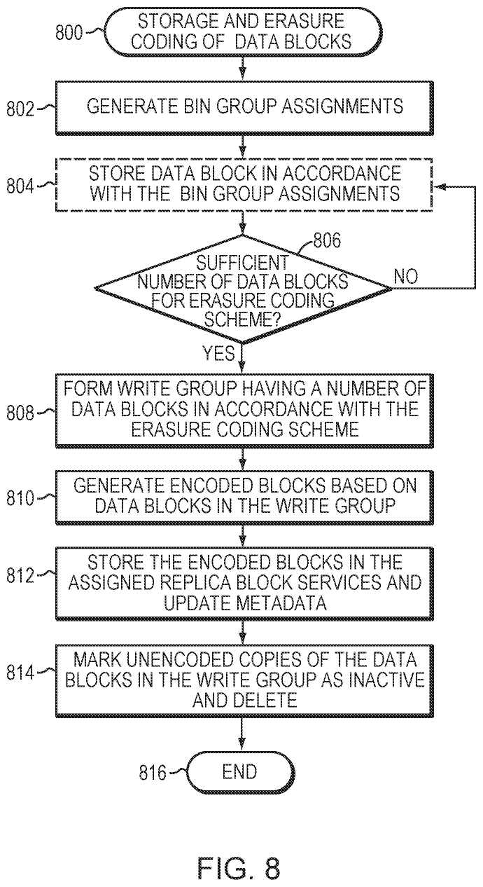

FIG. 8 is a flowchart illustrating operations of a method for storage and erasure coding of data blocks (block 800) in storage service 300. Broadly stated, the operations are directed to storing and the selecting data blocks for erasure coding, as well as operations for generating encoded parity blocks and bookkeeping operations that allow for freeing up of storage space previously occupied by unencoded copies of data blocks. At block 802, the storage service generates bin group assignments, i.e., assigns bins to bin groups, in a manner that streamlines the selected erasure coding scheme, as described herein. The bin group of blocks from different bins may be selected from data blocks of a pool of temporarily spooled blocks. That is, the data blocks of the different bins of the bin group may be selected according to bin from the pool of temporarily spooled blocks by bin. Notably, only the data blocks (i.e., unencoded blocks) need to be assigned to a bin, while the encoded blocks may be simply associated with the write group by reference to the data blocks of the write group.

At block 804, each (unencoded) data block is stored in accordance with the bin group assignment and, at decision block 806, a determination is rendered as to whether a sufficient number of data blocks are available for erasure coding. If it is determined that there are not enough data blocks for the erasure coding scheme, the storage service (e.g., block service) may create a data block of 0s or 1s as a substitute for an actual data block, and store that substituted block in accordance with the bin group assignment (block 804). Otherwise, at block 808, a write group is formed having a sufficient number of data blocks in accordance with the selected erasure coding scheme. At block 810, encoded parity blocks are generated based on the (unencoded) data blocks in the write group and, at block 812, the encoded parity blocks are stored in the assigned (replica) block services and the appropriate metadata mappings are updated. At block 814, (unencoded) copies of the data blocks in the write group are marked as inactive and are thereafter deleted to free up storage space, if needed. The method ends at block 816. Further, if a data block is rendered inaction, e.g., deleted, another data block assigned to a same bin as the deleted data block may be allotted as a replacement, and the metadata mappings of each replica block service may be updated to reference the replaced block and the appropriate parity blocks may be recomputed. The replacement block may be selected from the pool of temporarily spooled blocks.

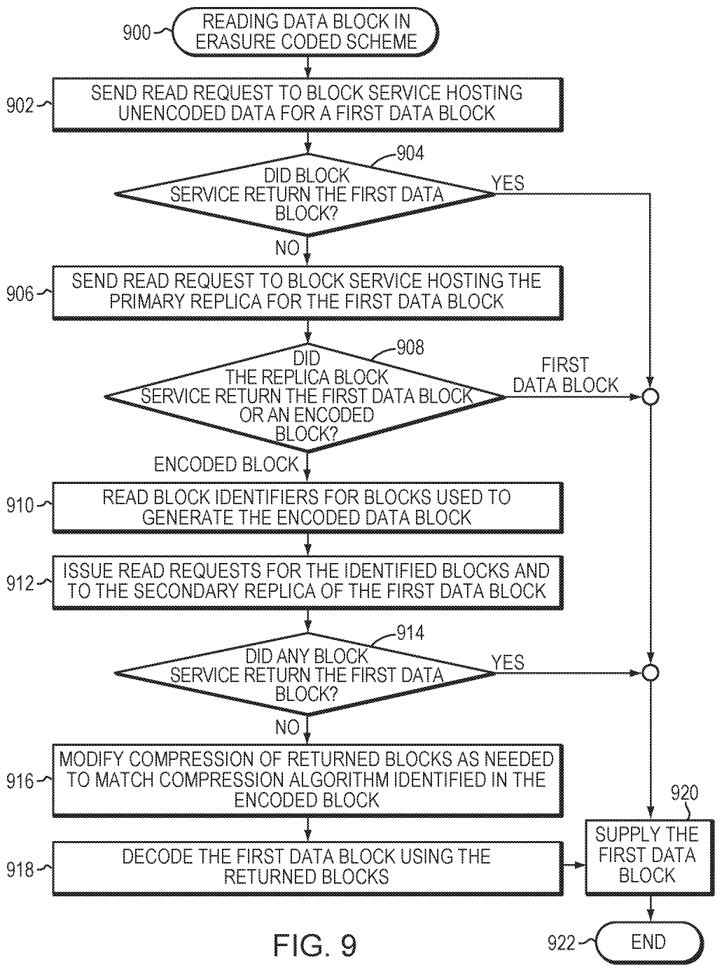

FIG. 9 is a flowchart illustrating operations of a method for reading a data block in an erasure coded scheme (block 900) of storage service 300. Broadly stated, the operations are directed to reading a data block which has been protected by an erasure coding scheme, as well as recreating the data block using other data blocks in a write group and one or more erasure coded blocks. FIG. 9 also illustrates method steps taken in a degraded read to retrieve a target block, e.g., a read operation in which the data block being stored for replica 0 is no longer available. The operations can include checking other block services, e.g., primary and secondary block services which host replica 1 and replica 2 versions of bins, for an unencoded version of the target block and reading other data blocks in a write group for purposes of decoding the encoded copy of the target block.

At block 902, a read request is sent to a block service hosting an unencoded copy of a first data block. At decision block 904, a determination is rendered as to whether the block service returned the first data block. If so, the first data block is supplied in response to the read request (block 920) and the method ends at block 922. Otherwise, the read request is sent to the master replica block service hosting the primary replica for the first data block (block 906). At decision block 908, a determination is rendered as to whether the master replica block service returned the first data block or encoded parity version of the first block. If the first data block is returned, the data block is supplied in the response to the read request (block 920) and the method ends at block 922. Otherwise, the block identifiers are read for the data blocks used to erasure encode (block 910) the data blocks and, at block 912, read requests are issued to the block services hosting the identified data blocks and the secondary replica for the first data block. At decision block 914, a determination is rendered as to whether any block service returned the first data block and, if so, the block is supplied in a response at block 920. Otherwise, compression of the returned blocks is modified (as needed) to match the appropriate compression algorithm identified in the encoded parity block (block 916) and the first data block is decoded using the returned blocks (block 918). The first data block is then supplied in the response (block 920) and the method ends at block 922.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software encoded on a tangible (non-transitory) computer-readable medium (e.g., disks, electronic memory, and/or CDs) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method comprising:
selecting a group of data blocks stored across a set of block services of storage nodes in a cluster, wherein bins are allotted to the block services across the cluster, wherein each of the group of data blocks is assigned to a corresponding bin based on a field of a block identifier (Block ID) computed from a content of the respective data block, and wherein each of the group of data blocks is duplicated at least once across the set of block services;
generating a first encoded parity block based on the group of data blocks;
storing the first encoded parity block on a first block service, wherein the first encoded parity block is indicated as an encoded replica; and
marking the at least one duplicate of each of the set of data blocks for deletion.

2. The method of claim 1 further comprising maintaining, by the first block service, a reference to a location of the first encoded parity block.

3. The method of claim 1 further comprising storing, with the first encoded parity block, Block IDs for each of the data blocks in the set of data blocks.

4. The method of claim 1 further comprising:
determining that a first data block of the set of data blocks cannot be read; and
decoding the first data block from the encoded parity block and remaining readable data blocks of the group of data blocks.

5. The method of claim 1 wherein generating the first encoded parity block based on the group of data blocks further comprises:
padding a first data block to match a size of the group of data blocks.

6. The method of claim 1, further comprising:
maintaining a table having an identifier of a block service (BS ID) associated with each of the group of data blocks and having an identifier associated with each of the at least one duplicates of the group of data blocks.

7. The method of claim 1, further comprising:
sending Block IDs of the group of data blocks to a second block service;
generating, by the second block service, a second encoded parity block based on the Block IDs; and
storing the second encoded parity block on the second block service.

8. The method of claim 1 wherein selecting a group of data blocks stored across a set of block services further comprises:
selecting the group of data blocks from a pool of temporarily spooled data blocks.

9. The method of claim 1 further comprising:
determining that a first data block of the group of data blocks is marked for deletion; and
selecting a replacement data block for the first data block from a pool of temporarily spooled data blocks, the replacement data block associated with a same bin identifier as the first data block, wherein the same bin identifier is determined from the field of the block ID of the respective data block.

10. The method of claim 1 wherein the first block service includes the at least one duplicate of each block of the group of data blocks.

11. A system comprising:
a cluster of nodes each coupled to one or more storage devices;
each node of the cluster including a processor and a memory, the memory having program instructions configured to,
select a group of data blocks stored across a set of block services of the nodes, wherein bins are allotted to the block services across the cluster, wherein each of the group of data blocks is assigned to a corresponding bin based on a field of a block identifier (Block ID) computed from a content of the respective data block, and wherein each of the group of data blocks is duplicated at least once across the set of block services;
generate a first encoded parity block based on the group of data blocks;
store the first encoded parity block on a first block service, wherein the first encoded parity block is indicated as an encoded replica; and
mark the at least one duplicate of each of the set of data blocks for deletion.

12. The system of claim 11 wherein the memory having the program instructions further comprises program instructions configured to maintain, by the first block service, a reference to a location of the first encoded parity block.

13. The system of claim 11 wherein the memory having the program instructions further comprises program instructions configured to store, with the first encoded parity block, Block IDs for each of the data blocks in the set of data blocks.

14. The system of claim 11 wherein the memory having the program instructions further comprises program instructions configured to,
determine that a first data block of the set of data blocks cannot be read; and
decode the first data block from the encoded parity block and remaining readable data blocks of the group of data blocks.

15. The system of claim 11 wherein the memory having the program instructions configured to generate the first encoded parity block based on the group of data blocks further includes program instruction configured to,
pad a first data block to match a size of the group of data blocks.

16. The system of claim 11 wherein the memory having the program instructions further comprises program instructions configured to,
maintain a table having an identifier of a block service (BS ID) associated with each of the group of data blocks and having an identifier associated with each of the at least one duplicates of the group of data blocks.

17. The system of claim 11 wherein the memory having the program instructions further comprises program instructions configured to,
send Block IDs of the group of data blocks to a second block service;
generate, by the second block service, a second encoded parity block based on the Block IDs; and
store the second encoded parity block on the second block service.

18. The system of claim 11 wherein the memory having the program instructions configured to select a group of data blocks stored across a set of block services further includes program instructions configured to,
select the group of data blocks from a pool of temporarily spooled data blocks.

19. The system of claim 11 wherein the first block service includes the at least one duplicate of each block of the group of data blocks.

20. A non-transitory computer-readable medium including program instructions on one or more processors, the program instructions configured to:
select a group of data blocks stored across a set of block services of storage nodes in a cluster, wherein bins are allotted to the block services across the cluster, wherein each of the group of data blocks is assigned to a corresponding bin based on a field of a block identifier (Block ID) computed from a content of the respective data block, and wherein each of the group of data blocks is duplicated at least once across the set of block services;
generate a first encoded parity block based on the group of data blocks;
store the first encoded parity block on a first block service, wherein the first encoded parity block is indicated as an encoded replica; and
mark the at least one duplicate of each of the set of data blocks for deletion.
